(19) United States
(12) Patent Application Publication
(10) Pub. No.: US 2008/0294878 A1
(43) Pub. Date: Nov. 27, 2008

(54) PROCESSOR SYSTEM AND EXCEPTION PROCESSING METHOD

(76) Inventors: Takafumi YUASA, Yokohama (JP); Hiroaki Nakata, Yokohama (JP); Koji Hosogi, Hiratsuka (JP); Masakazu Ehama, Ebina (JP); Fumitaka Izuhara, Kokubunji (JP); Kazushi Akie, Kokubunji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/101,437

(22) Filed: Apr. 11, 2008

(30) Foreign Application Priority Data
Apr. 13, 2007 (JP) 2007-105467

(51) Int. Cl. G06F 9/38; G06F 9/302; G06F 9/312

(52) U.S. Cl. 712/221; 712/234; 712/228; 712/E09.017; 712/E09.033; 712/E09.045

(57) ABSTRACT

When an error is detected in an error detecting unit in a processor system, the error detecting unit outputs an error signal to an interrupt control unit, and the interrupt control unit outputs a value of an error address register and a control signal to a program counter control unit and rewrites a value of a program counter to a value of an error address register. By this means, the branching process by an error interrupt is realized. In this case, when the error is detected, the process of saving the value of the program counter at the time of error occurrence is not performed, and a specific save register and a control circuit for the recovery to the address at the time of the error occurrence after the end of the error processing are not provided.

### CROSS-REFERENCE TO RELATED APPLICATION

The present application claims priority from Japanese Patent Application No. JP 2007-105467 filed on Apr. 13, 2007, the content of which is hereby incorporated by reference into this application.

### TECHNICAL FIELD OF THE INVENTION

The present invention relates to a microprocessor and its accompanying coprocessor. More particularly, it relates to an error processing of a microprocessor and a coprocessor in the case where an error occurs in the coprocessor.

### BACKGROUND OF THE INVENTION

In recent years, microprocessors have been mounted in various electric devices. These microprocessors are required not only to properly operate in normal times but also to appropriately operate at the time of error detection and error occurrence.

The processing of the microprocessor at the time of error occurrence differs depending on the microprocessor itself. In general, the state at the time of error occurrence is once saved in an internal special register to execute the error processing, and after the error processing is finished, the state at the time of error occurrence is read out from the special register to continue the former processing.

For example, in the microprocessor disclosed in Japanese Patent Application Laid-Open Publication No. 2004-362368 (Patent Document 1), program counter values indicating an address of a command being executed at the time of error occurrence and an address of a command to be executed next are stored in a specific save register, and branching to an interrupt process is performed. Then, after executing the interrupt process, the address of the command being executed which has been stopped and the address of the command to be executed next are written from the save register to a program counter, thereby recovering the former processing.

The error detection in the microprocessor includes the detection of data error in arithmetic operations caused by the four arithmetic operations. When the overflow in which the addition result exceeds the bit width of an arithmetic unit in the microprocessor occurs or when 0 is set as a divisor in the division, the error processing in accordance with the microprocessor is executed. For example, in Japanese Patent Application Laid-Open Publication No. 6-259117 (Patent Document 2), in a system comprising two processors, the four arithmetic operations are executed in the second processor, and when errors as mentioned above occur in the result thereof, the error occurrence is notified to the first processor.

### SUMMARY OF THE INVENTION

In a conventional microprocessor, when an error occurs, a command address and the like in the error occurrence are stored in a special register such as a save register. In the method in which the state of error occurrence is stored in a special register as described above, the save register and the control circuit for the recovery to the error occurrence address are necessary, which causes the problems that the hardware size in the entire microprocessor is increased and the time necessary for the processing at the time of error occurrence is increased.

Moreover, in a conventional microprocessor, the error check of the arithmetic operation result can be executed only under limited conditions such as the overflow and the division with the divisor of 0. Therefore, in order to determine whether the arithmetic operation result is kept within the range of a value which does not exceed the number of bits of the arithmetic unit and within the range of a certain value prescribed from the contents of the process to be executed, the check by a program is required.

More specifically, it is necessary to execute the comparison operations of the maximum value and the minimum value of the range of the prescribed values with respect to the arithmetic operation results. However, this causes the increase in the number of cycles necessary for the error detection when the number of arithmetic operations in which the confirmation of the range of the result values is necessary is large in the entire processing, and the performance is deteriorated when the normal values not the errors are obtained as the operation results.

An object of the present invention is to solve the problems described above and provide a microprocessor system having a small hardware size and accompanied with a coprocessor whose error processing load is small.

The above and other objects and novel characteristics of the present invention will be apparent from the description of this specification and the accompanying drawings.

The typical ones of the inventions disclosed in this application will be briefly described as follows.

For the solution of the above-mentioned problems, a processor system accompanied with a coprocessor according to the present invention comprises: address storing means to store a branch address; a program counter control unit to branch a process of a processor to an address value stored in the address storing means; and interrupt control means to control the program counter control unit by a command from the coprocessor, wherein the process of the processor is branched in accordance with a process result of the coprocessor.

Also, the coprocessor includes an error detecting unit which determines a presence of an error of the process result executed by the coprocessor, and the processor stores a branch address at the time of an error in the address storing means in advance by a register transfer command.

Further, the coprocessor includes a variable-length code processing unit which performs a coding process of an image codec, and an escape detecting unit which determines whether or not a decoded pattern is an escape pattern, and the processor stores a branch address of an escape processing in advance in the address storing means by a register transfer command.

The effects obtained by typical aspects of the present invention will be briefly described below.

According to present invention, the improvement in performance of the microprocessor system accompanied with a coprocessor can be achieved.

### BRIEF DESCRIPTIONS OF THE DRAWINGS

FIG. 1 is a block diagram showing the entire configuration of a processor system according to an embodiment of the present invention;

FIG. 2 is a flowchart showing a decoding process of a variable-length code executed by a coprocessor of the processor system according to the embodiment of the present invention;

FIG. 3 is a flowchart showing the processing at the time of error occurrence of the processor system according to the embodiment of the present invention; and

FIG. 4 is a flowchart showing the escape processing of the processor system according to the embodiment of the present invention.

### DESCRIPTIONS OF THE PREFERRED EMBODIMENTS

Hereinafter, an embodiment of the present invention will be described in detail with reference to the accompanying drawings. Note that components having the same function are denoted by the same reference numbers throughout the drawings for describing the embodiment, and the repetitive description thereof will be omitted.

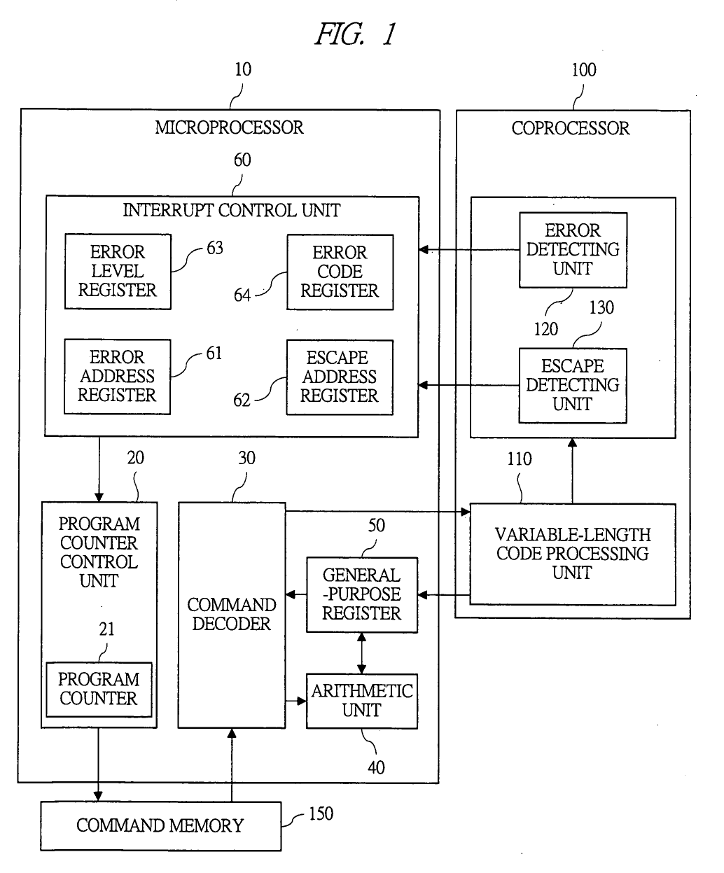

The entire configuration of the processor system according to an embodiment of the present invention will be described with reference to FIG. 1. FIG. 1 is a block diagram showing the entire configuration of the processor system according to the embodiment of the present invention. More specifically, FIG. 1 shows the system configured of a microprocessor 10 and a coprocessor 100 for the decoding process of a variable-length code in a video codec typified by MPEG-2 and others.

In FIG. 1, the processor system includes the microprocessor 10, a command memory 150 connected to the microprocessor 10 and the coprocessor 100.

The microprocessor 10 is configured of a program counter control unit 20, a program counter 21, a command decoder 30, an arithmetic unit 40, a general-purpose register 50, an interrupt control unit 60, an error address register 61, an escape address register 62, an error level register 63, and an error code register 64.

The coprocessor 100 is configured of a variable-length code processing unit 110, an error detecting unit 120, and an escape detecting unit 130.

In the system shown in FIG. 1, syntax analyses are performed in the microprocessor 10 and variable-length code processing such as the table lookup of a code table is performed in the coprocessor 100.

The microprocessor 10 appropriately reads out a command from the command memory 150 in accordance with the value of the program counter 21 incorporated in the program counter control unit 20, and this read command is decoded by the command decoder 30.

When the decoded command is the command to be executed by the microprocessor 10, the command is executed by the arithmetic unit 40 and the result is written back to the general-purpose register 50. When the decoded command is the code processing command to be executed by the coprocessor 100, the command decoding result is outputted to the variable-length code processing section 110 of the coprocessor 100.

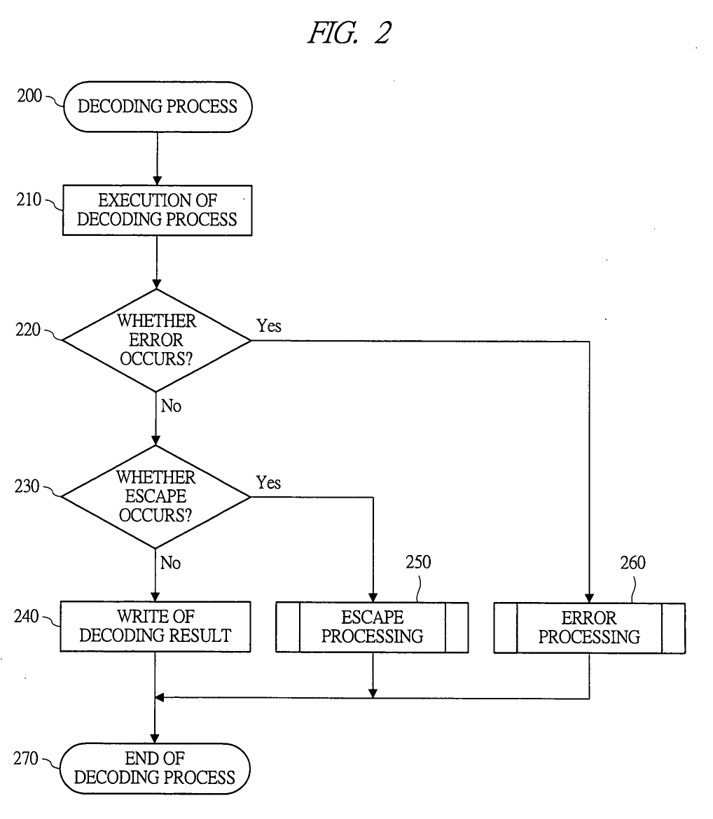

Next, the decoding process of a variable-length code executed by the coprocessor of the processor system according to the embodiment of the present invention will be described with reference to FIG. 2. FIG. 2 is a flowchart showing the decoding process of a variable-length code to be executed by the coprocessor of the processor system according to the embodiment of the present invention.

First, the decoding process is started (step 200), and the decoding process of data is executed in the variable-length code processing unit 110 (step 210). The presence of error occurrence is confirmed in the error detecting unit 120 at the time of the decoding process and after the decoding process (step 220). When the error has not occurred, the presence of the escape occurrence mentioned later is confirmed in the escape detecting unit 130 (step 230). When the escape has not occurred, the decoding result outputted to the microprocessor 10 is written in the general-purpose register 50 (step 240), and the decoding process is finished (step 270).

When the error occurrence is detected in the step 220, the procedure moves to the error processing (step 260), and when the escape occurrence is detected in the step 230, it moves to the escape processing (step 250).

Next, the error detecting method in the error detecting unit 120 of the coprocessor 100 and the error processing in the step 260 in the flowchart of FIG. 2 will be described in detail.

It is assumed here that the microprocessor 10 sets a branch destination address at the time when the error interrupt occurs in advance to the error address register 61 by a register transfer command. Also, the microprocessor 10 sets an error level value in advance to the error level register 63, which determines the operation of the interruption control unit 60 at the time of error occurrence, by the register transfer command. It is assumed that “error” or “warning” is set to the error level register 63 as an error level.

In the error detecting unit 120, the range of the decoding result set in advance, that is, the maximum value and the minimum value of the result is compared with the decoding result of the variable-length code processing unit 110. The maximum value and the minimum value are to be set as one of the variable-length code processing commands by the microprocessor 10.

The error detecting unit 120 detects an error when the decoding result exceeds the maximum value and when the decoding result falls below the minimum value. Further, in the variable-length code processing unit 110, an error is detected also when the variable-length code to be decoded cannot be decoded from the variable-length code table.

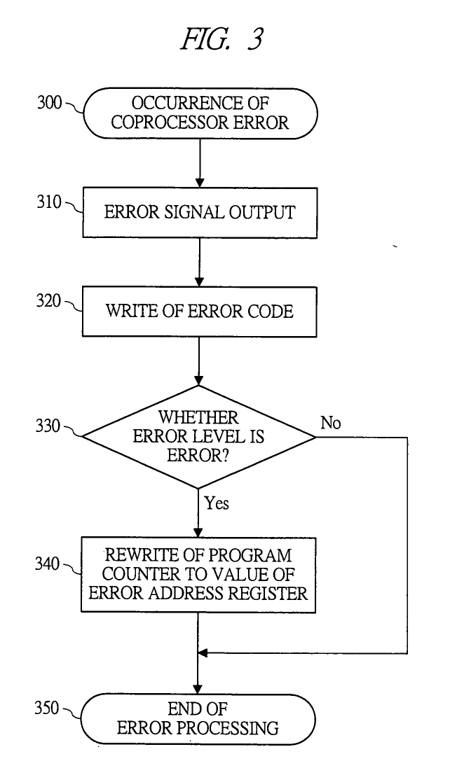

Next, the processing at the time of error occurrence in the processor system according to the embodiment of the present invention will be described with reference to FIG. 3. FIG. 3 is a flowchart showing the processing at the time of error occurrence in the processor system according to the embodiment of the present invention.

First, when an error is detected in the error detecting unit 120 (step 300), the error detecting unit 120 outputs an error signal to the interrupt control unit 60 (step 310). The interrupt control unit 60 writes the specified error codes in the error code register 64 (step 320).

Next, it is confirmed whether the setting value of the error level register 63 is an error or a warning (step 330). When it is the warning, the error processing is ended here (step 350). When it is the error, the value of the error address register 61 and the control signal are outputted to the program counter control unit 20. Then, the value of the program counter 21 is rewritten to the value of the error address register 61 (step 340) and the error processing is finished (step 350), and the branching process by the error interrupt is realized.

Here, even when an error is detected in the error detecting unit 120 and the branching occurs, the specific register is not provided and the value of the program counter 21 at the time of error occurrence is not saved.

In the decoding process of a variable-length code in an image codec, when an error occurs once in an image stream that is a sequence of variable-length codes, for example, the stream cannot be normally decoded until the end of the frame, and when an error occurs once, the following stream immediately thereafter cannot be processed normally. The time when the normal decoding process can be resumed is constant, that is, it is at the top of the next frame.

After the end of the error processing, if the return destination at the time of returning to the normal operation is constant, the branch to the processing at the top of a frame may be executed at the end of the error processing sequence by a usual command. By the process described above, the recovery to the error processing and the normal processing can be executed without storing the returning address even in the case of the error occurrence.

Next, the escape processing will be described. In an image codec, variable-length coding of a coefficient value obtained by the frequency conversion of an image is performed, and the coded coefficient value is transmitted. In codecs such as MPEG-2 and MPEG-4, when decoding the coefficient value, the special processing called an escape processing occurs in some cases.

When decoding the coefficient value, the value is decoded with reference to the variable-length code table defined by the codec standards. At this time, when a certain specific bit pattern called an escape appears in a stream, the coefficient value has to be decoded by changing the decoding method. In the case of MPEG-2, an escape bit pattern is “000001”, and the decoding is performed with using the following 6 bits as a run (the number of successions of the coefficient value 0) and the 12 bits as a level (coefficient value).

Whether or not the decoded pattern is an escape is checked each time when the coefficient value is decoded. When it is not an escape, the next coefficient decoding process is executed. Also, when it is an escape, the branching to the escape processing is performed to execute the processing, and after the escape processing, the following coefficient decoding is executed.

When the decoding process of a coefficient is performed only by a program, the check of the escape pattern of a decoding result has to be performed by a command each time when the decoding of a coefficient value is performed, which causes the deterioration of the processing performance. Even when the decoding result is not an escape pattern, the check thereof has to be performed, and unnecessary processing increases. Therefore, the escape processing is performed in the same manner as the error processing mentioned above.

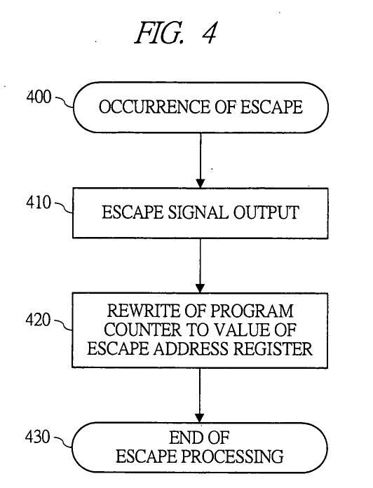

Next, the escape processing in the step 250 of the processor system according to the embodiment of the present invention will be described with reference to FIG. 4. FIG. 4 is a flowchart showing the escape processing of the processor system according to the embodiment of the present invention.

First, the microprocessor 10 sets a branch destination address at the time of occurrence of an escape interrupt in advance to the escape address register 62 by a register transfer command.

At the time of escape occurrence (step 400), an escape detection signal is outputted from the escape detecting unit 130 to the interrupt control unit 60 (step 410). When the escape detection signal is inputted, the address set in the escape address register 62 and a control signal are outputted from the interrupt control unit 60 to the program counter control unit 20. Then, the value of the program counter 21 is rewritten to the value of the escape address register 62 (step 420), and the escape processing is finished (step 430) and branching process by the escape interrupt is realized.

The escape processing mentioned here indicates the decoding process of the run and the level which have been coded with the fixed-length codes. After the escape processing is finished, the microprocessor 10 executes the branching to a command address to execute the coefficient decoding command. By executing such processing, the escape processing can be performed by the microprocessor in the variable-length coding processing in the image codec without deteriorating the performance thereof.

In the embodiment described above, the variable-length coding processing of an image codec has been mentioned as an example. However, the present embodiment can be applied in the same manner also to the process where the continuation of the command being executed at the time of the error occurrence is not required after the finish of the error processing.

In the foregoing, the invention made by the inventors of the present invention has been concretely described based on the embodiment. However, it is needless to say that the present invention is not limited to the foregoing embodiment and various modifications and alterations can be made within the scope of the present invention.

1. A processor system accompanied with a coprocessor, comprising:
address storing means to store a branch address;
a program counter control unit to branch a process of a processor to an address value stored in the address storing means; and
interrupt control means to control the program counter control unit by a command from the coprocessor,
wherein the process of the processor is branched in accordance with a process result of the coprocessor.

2. The processor system according to claim 1,
wherein the coprocessor includes an error detecting unit which determines a presence of an error of the process result executed by the coprocessor, and
the processor stores a branch address at the time of an error in the address storing means in advance by a register transfer command.

3. The processor system according to claim 2,
wherein the processor includes error level storing means to determine an operation of the interrupt control means at the time when an error occurs in the coprocessor,
the processor stores either one of two error levels in advance in the error level storing means by a register transfer command, and
when a first error level value is stored in the error level storing means at the time of occurrence of an error in the coprocessor, the interrupt control means branches the process of the processor to a branch address stored in the address storing means, and when a second error level is stored in the error level storing means, no branching is executed.

4. The processor system according to claim 2,
wherein the coprocessor includes a variable-length code processing unit which performs decoding process of a variable-length code, and an error detecting unit which confirms a presence of error occurrence from a range of decoding result of the variable-length code processing unit.

5. The processor system according to claim 4,
wherein the processor notifies a maximum value and a minimum value of the range of the decoding result to the coprocessor by a variable-length code processing command.

6. The processor system according to claim 4,
wherein the processor stores a branch address for performing a process at a top of a next frame of an image stream in advance in the address storing means by a register transfer command, and
at the time of occurrence of an error in the coprocessor, the processor performs branching to an address where the process at the top of the next frame of the image stream is performed.

7. The processor system according to claim 1,
wherein the coprocessor includes a variable-length code processing unit which performs a coding process of an image codec, and an escape detecting unit which determines whether or not a decoded pattern is an escape pattern, and
the processor stores a branch address of an escape processing in advance in the address storing means by a register transfer command.

8. An exception processing method in a processor system accompanied with a coprocessor, comprising the steps of:
storing a branch address at the time of occurrence of an error of the coprocessor in address storing means;
notifying error occurrence of the coprocessor; and
branching a process of the processor to the branch address stored in the address storing means.

9. A microprocessor accompanied with a coprocessor,
wherein a command which can specify a maximum value and a minimum value of an arithmetic operation executed by the microprocessor or the coprocessor is provided.

10. The microprocessor according to claim 9, further comprising:
range error detection means for comparing the maximum value and the minimum value of the arithmetic operation specified by the command with an arithmetic operation result of a command,
wherein the range error detection means outputs an error signal when the command arithmetic operation result exceeds the maximum value of the arithmetic operation or when the command arithmetic operation result falls below the minimum value of the arithmetic operation.

11. A coprocessor accompanying a microprocessor comprising:
a register for storing a maximum value of an arithmetic operation inputted from the microprocessor;
a register for storing a minimum value of an arithmetic operation inputted from the microprocessor; and
range error detection means for determining an arithmetic operation result,
wherein the range error detection means outputs an error signal to the microprocessor when a coprocessor arithmetic operation result exceeds the maximum value of the arithmetic operation or when the coprocessor arithmetic operation result falls below the minimum value of the arithmetic operation.

12. A microprocessor accompanied with a coprocessor, comprising:
error interrupt address storage means; and
interrupt control means,
wherein, when an error signal from the coprocessor or an error signal from the microprocessor is input to the interrupt control means, the interrupt control means branches a process of a processor to an address stored in the error interrupt address storage means without storing an address at the time of error occurrence.

13. The microprocessor according to claim 12, further comprising:
error code storage means for storing an error code at the time of error occurrence; and
error level storage means for storing an error processing method at the time of error occurrence,
wherein, when error occurrence is detected by error detection means, the interrupt control means stores an error code to the error code storage means and branches a process of a processor to an address stored in the error interrupt address storage means when an error level stored in the error level storage means is error, and stores an error code to the error code storage means when the error level is warning.
